(19) United States
(12) Patent Application Publication
(10) Pub. No.: US 2019/0188893 A1
(43) Pub. Date: Jun. 20, 2019

(54) SIMULATED REALITY DATA REPRESENTATION SYSTEM AND METHOD

(71) Applicant: DATAVIEW VR, LLC, New York, NY (US)

(72) Inventors: Brennan John McTernan, Fanwood, NJ (US); Andrew James Maggio, Hoboken, NJ (US); Lyron L. Bentovim, Demarest, NJ (US)

(21) Appl. No.: 15/887,891

(22) Filed: Feb. 2, 2018

Related U.S. Application Data
(60) Provisional application No. 62/607,296, filed on Dec. 18, 2017.

(51) Int. Cl. G06T 11/60; G06T 15/20; G06T 19/00

(52) U.S. Cl. CPC G06T 11/60; G06T 15/20; G06T 2200/24; G06T 19/003; G06T 19/006

(57) ABSTRACT

A data representation system is provided. The data representation system includes a display device and a non-transitory memory containing computer-readable instructions operable to create a simulated reality. The data representation system also includes a processor configured to process the instructions for carrying out steps for creating the simulated reality. The system accesses source data having four or more attributes. The system converts a portion of the source attributes to representative attributes. The system accesses the representative attributes and forms an agglomerated asset that is based on a default asset. Each of the representative attributes forms a distinct characteristic of the asset.

### CROSS-REFERENCE TO RELATED APPLICATION

This application claims priority to U.S. Provisional Application No. 62/607,296 filed on Dec. 18, 2017, entitled “Virtual Reality with Natural Data Representation”, which is hereby incorporated by reference in its entirety.

### FIELD

The present invention relates to systems and methods for representing data in a simulated reality.

### BACKGROUND

In traditional data representations, the information transmitted can be difficult for a user to understand, visualize, and assess. As a result, numerous companies exist that provide systems just to help understand data, including examples such as Tableau. Complex presentation systems, such as those disclosed in U.S. Pat. No. 9,665,988, lack any tangible representative qualities that allows a user to analyze, regroup, or update data in a quick accessible way. Additionally traditional systems put greater pressures on the computer system because in order to cater to larger databases, more intricate analysis methods or greater usage time on the system is required for the user to understand and assess the data. Also, lacking user accessible display features that makes the system less accessible to the user increases error in the system as users miss important relationships lost in the complexity. Therefore, an improved system, graphical display, or user interface for accessing, analyzing, updating, regrouping, or modifying data is desirable.

### SUMMARY

In accordance with various embodiments, a data representation system is provided. The data representation system includes a display device and a non-transitory memory containing computer-readable instructions operable to create a simulated reality. The data representation system also includes a processor configured to process the instructions for carrying out steps for creating the simulated reality. The system accesses source data a plurality of attributes. The system converts a portion of the source attributes to representative attributes. The system accesses the representative attributes and form an agglomerated asset being based on an asset. Each of the representative attributes form a distinct characteristic of the asset.

The processor is further configured to populate the simulated reality with the agglomerated asset in a spatial relationship to one another. Two or more agglomerated assets are spatially arranged in the simulated reality. The data representation system of claim 3, wherein the processor is further configured to render the simulated reality on the display device from changeable viewpoints of the populated simulated reality. The data representation system further comprises an input device, wherein the processor is further configured to receive information from the input device allowing a user to change the viewpoint of the simulated reality. The different viewpoints allow different groups of agglomerated assets to be viewed on the display device relative to one another from different perspectives. Each source attribute has a direct relationship to a representative attribute. Different source attributes have different relationship types forming the relationship to the corresponding representative attribute. At least one relationship type is an algorithmic relationship. The algorithmic relationship is a scaler algorithmic relationship that converts a range of variables into a discrete representative attribute. The discrete representative attribute is at least one of a color, an appendage, a size, a shape, or a dependent entity of the asset. At least one relationship type is a direct relationship having a preassigned value input by a user.

The direct relationship is established by assigning a source data variable to a discrete representative attribute including at least one of a color, an appendage, a size, a shape, or a dependent entity. The representative attribute is a secondary agglomerated asset being related to the agglomerated asset. The asset is a natural construct. The asset is a manmade construct. The simulated reality is a virtual reality platform. The data representation system includes further comprises a real environment input device. The simulated reality is an augmented reality platform and the processor receives information from the real environment input device and renders the agglomerated asset in the display of real environment on the display device. The simulated reality is a 3D representation on a viewing screen. The simulated reality includes an input platform that allows assigning or modifying information relative to each attribute or allows adding an attribute and associated information to the representative data.

### BRIEF DESCRIPTION OF THE DRAWINGS

FIG. 1 illustrates an example mapping table of source attributes and represented attributes for converting source data to agglomerated assets according to an embodiment;

FIG. 2 illustrates an example detailed table of source attributes and represented attributes for mapping source data relating to multiple entities to multiple agglomerated assets based on the table of FIG. 1;

FIG. 3 illustrates a block diagram of a computing device for converting source data into agglomerated assets and/or for implementing the simulated realty environment according to various embodiments herein;

FIG. 4 illustrates a block diagram of a process for converting source data into agglomerated assets and/or for implementing the simulated realty environment according to various embodiments herein;

FIG. 5 illustrates an example mapping table of source attributes and represented attributes for converting source data to agglomerated assets of FIG. 1 with values included;

FIGS. 6A-6B illustrates an example detailed table of source attributes and represented attributes for mapping source data relating to multiple entities to multiple agglomerated assets based on FIG. 5;

FIG. 7 illustrates an example agglomerated asset interface;

FIG. 8 illustrates an example relationship interface;

FIG. 9 illustrates an example simulated reality environment with agglomerated assets and an interface;

FIG. 10 illustrates an example source data interface in a simulated reality environment;

FIG. 11 illustrates another view of the example simulated reality environment with agglomerated assets and an interface;

FIG. 12 illustrates another view of the example simulated reality environment with agglomerated assets;

FIG. 13 illustrates another view of the example simulated reality environment with agglomerated assets; and

FIG. 14 illustrates another view of the example simulated reality environment with a zoomed in view of agglomerated assets.

### DETAILED DESCRIPTION

In providing a data presentation, it is valuable to convey the information or allow the user to interact with the information in an interface that transcend the inherent features of the data in order to improve accessibly, usability, or clarity for the user. For example, an appropriate simulated reality object, world, area, or similar environment can be presented to improve the interactive experience or user understanding of the data. When the interaction or presentation of the data is sufficiently improved the ability of the user to asses, use, modify, or other capitalize on the value of the data is also improved. While other methods have been created direct data representation data to users, these methods lack an inherent accessibility in the interface or the understanding of the underlying data. Thus, greater pressures on the computer system is required in order to cater to larger databases, more intricate analysis methods, or greater usage time on the system in order for the user to understand and assess the data. Provided herein is a way to improve the functionality of the interaction with stored system data allowing for a broader reduction in computer system requirements while improving the accessibility to the end user.

In various embodiments, the systems, devices, and methods discussed herein provides a platform allowing users to see or experience data in 3D space or in a 3D simulated space in a way which leads to better (more accurate, more impactful) and faster insights than is possible when using traditional systems such as 2D data systems. The system allows users to see connections between variables in complex data sets in ways that traditional systems do not allow. 3D space also allows users to present data in a way that the intended audience can more quickly grasp and connect with the material, ultimately better retaining and understanding the content of the presentation.

Furthermore, the systems, devices, and methods discussed herein can be equipped with conversion utility's that allow data sources to be converted to assets having assets made up of natural constructs, man-made constructs, or other suitable constructs that allow for an intuitive reception of the information. The format and/or constructs allow users to draw intuitive conclusions from data based on immersive experience leading to new and faster insights.

Disclosed are systems and methods for simulated reality (SR) data representations conversions and SR interfaces. The SR data representations conversions are achieved by converting attributes of source data to attributes of representative data. The SR interface platforms are achieved by forming one or more agglomerated assets and populating a simulated reality with those agglomerated assets.

SR systems include environments that are three-dimensional (3D) representations of real or simulated worlds. SR systems can be displayed on two-dimensional (2D) devices such as a computer screens, mobile devices, or other suitable 2D displays. SR systems can also be displayed in 3D such as on a 3D display or hologram. Examples of SR include virtual reality (VR), augmented reality (AR), and traditional 3D representations on a 2D displays. SR systems immerse users in environments that are either partially or entirely simulated. In AR environments, users interact with real world information via input sensors on the device, providing a partially simulated environment. In VR environments, the user is fully immersed in a 3D simulated world. Each type of SR system may have objects that are simulations (i.e., corresponds to) real world items, objects, places, people, or similar entities. The objects or conditions can also provide feedback through haptics, sound or other suitable methods.

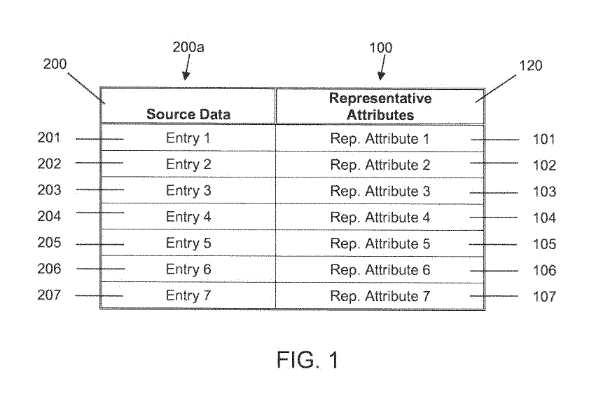

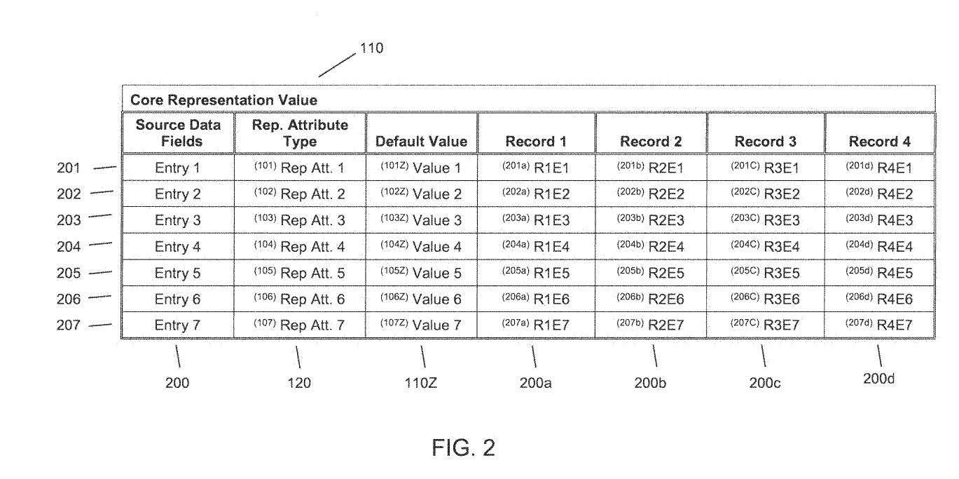

In accordance with various embodiments, the SR environments discussed herein are populated with or otherwise representative of source data. FIGS. 1 and 2 are illustrative of generic source data 200. The source data pertains to any set of data to be analyzed, monitored, manipulated, updated, or otherwise handled by a user. The data can relate to any suitable information that is or can be stored in a database or similar systems. The SR system at least partially indirectly displays the source data. For example, the source data is at least partially represented by proxy in the SR environment.

The source data 200 includes source attributes (e.g., 201-207). In various embodiments, source attributes (e.g., 201-207) relate to fields contained in each record 200a of the source data 200. The SR system allows for the comparison, evaluation, analysis and/or modification of multiple records (e.g., 200a-e shown for example in FIG. 2). The source attributes are mapped to or otherwise correspond to representative data 120 having representative attributes (e.g., 101-107). In accordance with various embodiments, the representative attributes (101-107) are the direct or proxy representations of the source attributes (e.g., 201-207). As proxy representation of the source attributes (e.g., 201-207), the representative attributes (101-107) are independent representations that can be entirely unrelated to type of information in the source attributes. This difference can include nature of information, dimensions, or characteristic. In various embodiments, any variable held in an entry in the source data 200 can be mapped to any proxy in the representative attributes. In some embodiments, users can modify entries in the source data 200 or mapping to the representative attributes while in the SR interface. The representative attributes (101-107) are compiled into one or more agglomerated assets 100 for the proxy representation of the source data 200. The agglomerated asset being based on an asset 110 in the SR system.

In accordance with various embodiments, the system can import data or the user enters data into a database or similar collection application such as a spreadsheet. As illustrated in the table of FIG. 2 (e.g., example database), each data entry includes one or more variables, components, values, or attributes. In one example, each record contains information on a plurality of variables. In one example, there are more than four entry fields with each field available to store a variable of the record that map to four representative attributes of an asset. In another example, there are more than five entry fields that map to five representative attributes of an asset. In a preferred example, there are more than six entry fields that map to six representative attributes of an asset. In a another example, there at least ten entry fields that map to at least ten representative attributes of an asset. The greater the number of fields the greater the value of the representation as an agglomerated asset 100 because it allows for greater accessibility and comprehensive interpretation by the user. For example, an SR environment might include hundreds of trees with each tree having one or more of x location, y location, z location, height, width, type of tree, color of leaf, color of bark, texture, birds, insects, fruit type, fruit color, fruit quantity, tree house, and swing. In this example, a single record can be displayed as an agglomerated asset with 16 different variables represented for comparison to hundreds of other different records. Furthermore, time can be applied by dynamically rendering the environment as data changes over time or each agglomerated asset can have time as an attribute, represented by the life cycle of the tree (e.g. new record is a young tree old record is an old tree).

In accordance with various embodiments, the SR system maps each field (201-207) in each record (200a-200d) of the source data 200 onto different representative attributes 120 (e.g., 101-107). Each record corresponds to a different agglomerated asset (e.g., any one of 100a-d). In accordance with various embodiments, each of the representative attributes 120 (e.g., 101-107) can be an intrinsic characteristic of the asset 110. The representative attributes 120 (e.g., 101-107) can include default values 110z (e.g., 101z-107z) that associates starting values to the representative attributes 120 (e.g., 101-107) prior to any conversion. The default values correlate to values and types set for the source attributes (e.g., 201-207).

In accordance with various embodiments, data is represented in an SR format to provide user perspective and visualization of the various attributes of the data. For example, the entries, being variables, values, data-points, characteristics, or attributes of the record, are represented in the representative attributes 120 by proxies, analogies, or other representations that can define characteristics of the asset. Generally, the assets are based on assigned categories of objects. As discussed in more detail below the asset can include a particular construct, preferably a tangible construct. In one example, which will be elaborated on below, the asset can be a plant such as a tree. In this example, a person of ordinary skill in the art can understand that the asset includes distinct intrinsic characteristics. For example, as a tree, the asset has the distinct intrinsic characteristics that a tree has. The distinct intrinsic characteristics of a tree can include one or more of tree type, height, leaf type, leaf color, shape, fruit type, fruit quantity, stage in life cycle, stage in season, time of day, illumination, reaction to the environment (e.g., branches do or don't move when the wind blows, branches do or don't accumulate snow, or reaction), position in the forest, or similar intrinsic characteristics. While discussed here as an example of a tree, other assets (particular ones having tangible-constructs discussed in detail below) will have other unique distinct intrinsic characteristics that form the asset. By modifying these intrinsic characteristics, a user comparing assets is more easily able to see patterns on important information due to the context. In various embodiments, however, characteristics of the asset can also be modified that are not intrinsic to its form. For example, the visual aspects of a tree can be partially or totally hidden rendering them invisible. The ability render a portion of a tree invisible is not intrinsic to the nature of a tree as users would not have a contextual association with that characteristic of a tree.

In accordance with various embodiments, at least a portion of the relevant source data attributes are assigned, converted, or otherwise mapped to distinct intrinsic characteristics of the asset thus forming the representative attributes. The use of assets, particularly contextually based assets, enhances user's ability to notice patterns that are otherwise difficult to discern in traditional representations that use, for example, arbitrary or non-analogous forms to represent the data.

As indicated above, the mapping may include a conversion from the source attribute to the representative attribute. The conversion from the source attributes to the data attributes can be performed algorithmically. The conversion can be any of a number of different relationship types including discrete relationships, scaled relationships, directly assigned relationship. The relationships can be functions such as linear functions, step functions, logarithmic functions, or other mathematical expressions.

In accordance with various embodiments, the SR system can represent the source data by proxy, directly, or as a combination of proxy and direct representation. Using the example above, the SR system can show data as the tree type. For example, if the data relates to corporate information and industry information, the industry that a corporation operates in may be represented by tree type (i.e., a proxy representation). The tree can also have a label applied to it to identify it as the corporation (i.e., direct representation of the data).

In accordance with various embodiments, the SR system maps records having multi-variable data points (i.e., entries) onto an assets in 3D space. Assets based on multi-variable data points are referred to herein as agglomerated assets 100. In accordance with various embodiments, the SR system maps at least a portion of the entries of each record of the source data to assets forming agglomerated assets. For example, an entire record of a data set can be compiled into a single agglomerated asset and displayed to a user. In another example, a single record can be shared between different assets. In yet another example, different records can be combined into a single agglomerated asset. A plurality of agglomerate assets can then be displayed in the SR environment, which forms a user accessible environment of the agglomerated assets suitable for efficient utilization of the information contained therein. Furthering the tree example above, a plurality of agglomerated assets having trees as core representations can form one or more forests in the SR environment. By entering into the SR environment, the user can immerse themselves in this tangible representation of the source data and more efficiently understand, manipulate, or analyze the complex relationships.

Frequently source data can have tiers of information, a hierarchy of information or different types of information contained in one or more records that can be represented by different types of assets or agglomerated assets. In accordance with various embodiments, this information can be displayed in the SR environment as multiple assets, or a hierarchy of assets. For example, a primary asset can include a related secondary asset. In some examples, the secondary asset may include a related tertiary asset. Again, returning to the example above, a primary asset may have an asset in the form of a forest with the SR environment displaying multiple different forests. In one example, the primary asset may be representative of an industry as the forest. Each company in the industry can be represented by the secondary asset as a tree. Thus, a secondary asset may be assigned to or otherwise contextually related to a primary asset, one of which may be an agglomerated asset.

Of note, assets in a SR environment do not necessarily have to be correlated to source data. The mountains in the background may be an asset or assets that is/are unrelated to source data. Agglomerated assets by definition are related to source data via the representative attributes that make up the agglomerated asset.

As discussed above, assets can be made up of constructs. Constructs include tangible-constructs and arbitrary-constructs. Tangible-constructs include natural constructs, man-made constructs, or other suitable forms that people interact with in the real world and allow for an intuitive reception of the information. Arbitrary constructs include arbitrary or abstract forms having no real world association. Arbitrary or abstract forms include for example, generic geometric shapes (e.g., spheres, cones, prisms, etc.) or complex geometric shapes including combination of generic geometric shapes or geometric shapes with arbitrary modifications thereto (e.g., shapes with arbitrary appendages, extrusions, or cutouts). As an example to distinguish tangible-constructs and arbitrary-constructs, a toy ball may be a sphere but because as a ball it has function and a real world association, thus it would be a tangible-construct. Whereas, a geometric sphere absent associative information such as a real world function is merely an arbitrary-construct.

The format of a tangible-construct allows users to reach intuitive conclusions from data based on an immersive experience in the SR environment by being able to draw on experiences from the real world leading to faster and unique insights that would otherwise increase the system burdens of traditional platforms or would not be possible. In accordance with various embodiments, a natural construct includes a form taken from nature otherwise unaffected by human interference. For example, natural constructs can come from biological constructs or non-biological constructs. Biological constructs can include plants (e.g., algae, fungus, flowers, trees, etc.) or animals (amebae, aquatic, aviary, reptile, mammal, human etc.). Non-biological constructs can include minerals, landscape, geography (e.g., lakes, rivers, oceans, mountains, deserts, etc.) topologies, or astronomy (e.g., asteroids, comets, planets, stars, solar systems, galaxies, the universe, etc.) as examples. Different constructs can be combined as well. For example, combinations can include forests on various topologies, animals within forests, small ecosystems (e.g., a bacterial ecosystem), large ecosystems (e.g., the rain forest), or other suitable natural forms. In accordance with various embodiments, a man-made construct includes a form placed into the real world by human activity. For example, man-made constructs can include roads, bridges, buildings (houses, offices, libraries, churches, government structures, etc.), manufactured goods (consumer items, industrial items, etc.), geopolitical entities (cities, counties, states, regions, countries, etc.), intellectual goods (books, maps, art, etc.), vehicles (cars, trains, aircraft, watercraft, spacecraft, etc.) or other suitable artificial (i.e. tangible but not natural) forms. In accordance with various embodiments, a combination construct includes a form that is a combination of a natural construct and a man-made construct. For example, combination constructs can include a person dressed with consumer goods, a manicured garden, an eco-system with human intervention, and a cosmic landscape (e.g., one that includes a planet, moon, satellites, etc.).

In accordance with other embodiments, assets can be made up of arbitrary-constructs. While the preferred embodiments discussed herein are directed to asset based on tangible-constructs, the various concepts discussed herein are also applicable to arbitrary-constructs. As an example, assets having arbitrary-constructs can be represented as hierarchical agglomerated assets.

As discussed above, the SR system allows users to recognize patterns because in various embodiments the assets are associated with the real world and not merely abstract concepts like geometric shapes. A user associates trees as having color (thus, color is intrinsic to a tree), even if a tree in the SR environment is not a natural color (e.g., pink) the natural association of trees having color provides an added impression to the user. Even objects that are commonly associated with a tree can be intrinsic to a user because of their association. For example, a tree may have a tree swing. Thus, the representation is associative to a user and therefore intrinsic. Whereas, a triangle does not have a color. Consequently, a pink or any other colored triangle are less associative or intuitive since it is merely abstract.

Additionally, the term real world is used herein to account for the common experience of humans outside of abstract or simulated domains. Non-real world experience can also form a basis for non-abstract concepts, however. The movies are non-real world but none-the-less provide a contextual domain that can support the associations that provide users with an understanding of tangible-constructs. For example, Star Trek television series, although fanciful and fictional, is tangible because a user can have associations from it and therefore a simulated Star Trek universe can serve as a tangible (man-made) construct. Whereas, a universe containing only shapes (whether they have color or variation) is abstract and provides the user with no association, either from the real-world or from another contextual domain.

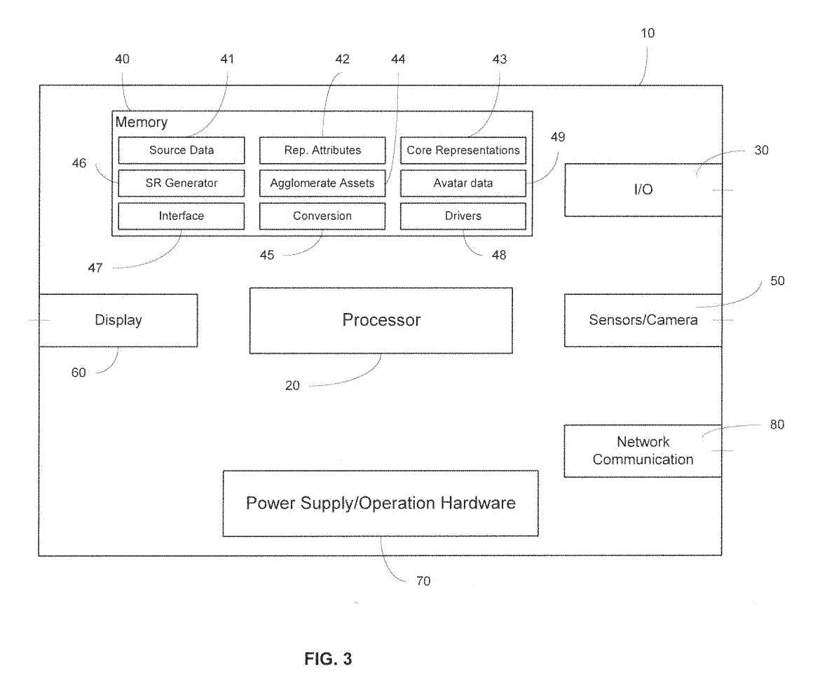

FIG. 3A is a simplified block diagram of a computing device 10 for conversion of a source data to representative data and/or for implementing the SR environment. The representative data can be combined by the system to form one or more agglomerated assets. The computing device 10 can support and implement a portion of the systems illustrated in the other figures shown and discussed herein or can support and implement all of the systems illustrated in the other figures shown and discussed herein. The computing device 10 can support and implement a portion of the systems illustrated in the other figures shown and discussed herein or can support and implement all of the systems illustrated in the other figures shown and discussed herein. For example, computing device 10 may be a part of a single device or may be segregated into multiple devices that are networked or standalone. Devices 10 need not include all of the components shown in FIG. 3 and described below. In various embodiments, the device 10 can include an interface, display, camera, or sensors. In various examples, the device 10 can exclude one or more of an interface, display, camera, or sensors.

In accordance with various embodiments, as illustrated in FIG. 3, the SR computing system 10 includes one or more processing elements 20, an input/output connection 30, one or more memory components 40, a camera and/or sensors 50, a display 60, a power source 70, a networking/communication interface 80 and/or other suitable equipment for implantation of an SR platform, with each component variously in communication with each other via one or more systems busses or via wireless transmission means, each of the components will be discussed in turn below. The memory components 40 include one or more of source date 41, rep. attributes 42, core representations 43, agglomerate assets 44, conversion module 45, SR generator 46, interface 47, drivers 48, and avatar data 49.

As indicated above the SR computing device 10 includes one or more processing elements 20. The processor 20 refers to one or more devices within the computing device that is configurable to perform computations via machine-readable instructions stored within the memory components 40 of the 3D the SR computing system 10. The processor 20 can include one or more microprocessor (CPUs), one or more graphics processing units (GPUs), and one or more digital signal processors (DSPs). In addition, the processor 20 can include any of a variety of application specific circuitry developed to accelerate the SR computing device 10. The one or more processing elements may be substantially any electronic device capable of processing, receiving, and/or transmitting instructions. For example, the processing element may be a microprocessor or a microcomputer. Additionally, it should be noted that the processing element may include more than one processing member. For example, a first processing element may control a first set of components of the computing device and a second processing element may control a second set of components of the computing device, where the first and second processing elements may or may not be in communication with each other, e.g., a graphics processor and a central processing unit which may be used to execute instructions in parallel and/or sequentially.

In accordance with various embodiments, one or more memory components 40 are configured to store software suitable to operate the SR computing device 10. Specifically, the software stored in the memory launches SR environments via an SR generator 46 within the SR computing device 10. The SR generator 46 is configured to render SR environments suitable to be communication to a display. In order to render the SR environment, the SR generator 46 pulls the agglomerated assets from agglomerated assets memory 44 and instantiates them in a suitably related environment provided by the SR generator. The agglomerated assets are stored in the agglomerated assets memory after the conversion engine 45 converts the source data 41 to representative attributes 42. Information from the representative attributes 42 is combined with the asset 43 to form the agglomerated assets, which are stored in the agglomerated assets memory 44. The source data 41 can locally be stored in a database, file, or suitable format or it can be stored remotely. The conversion engine 45 combs each of the records within the source data 41 for entries and applies a conversion function suitable to convert each of the entries in the record to a corresponding representative attribute. The conversion function modifies the default value of the representative attribute type assigned to each field of the record. This forms a table of representative attributes that are assigned to an asset for each record forming the agglomerated asset.

Each of the source data memory 41, the representative attributes memory 42, the asset memory 43, and the conversion functions within the conversion engine 45 can be dynamically updated via the interface 47. In various embodiments, the process 20 can access the SR generator 46 and interface memory 47 and instantiate a user interface within the SR environment allowing a user access to review or modify the source data memory 41, the representative attributes memory 42, the asset memory 43, and the conversion functions within the conversion engine 45. Specifically, modification of the conversion functions allows source attributes to be mapped to representative attributes differently such that the SR generator and processor render a modified SR environment in response to the user modifications.

The SR generator 46 configured to provide instructions to the processor 20 in order to display images to the proper display in the proper format such that the image is presented in 3D or as a 3D simulation. Thus if the display 60 is a screen, the display is in a 3D simulation. If the display 60 is a hologram projector, the display is in actual 3D. If the display 60 is a VR headset the display can be provided in stereo allowing the display headset to provide a 3D simulation. The SR generator 46 can also access information from the avatar data 49 in order to locate the user avatar in the SR environment and/or other avatars in the SR environment with the user's avatar. The avatar data 49 can receive communications from the sensor/camera 50, the network communications 80, or the I/O 30 for information, characteristics and various attributes about the user, the user's position, actions, etc. in order to provide the system sufficient information to form, manipulate and render the user's avatar within the SR environment. The same applies for the avatar of other users.

In accordance with various embodiments, the SR computing system 10 includes one or more network communication connections 80. The network communication connections 80 are configured to communicate with other remote systems. The networking/communication interface receives and transmits data to and from the computing device. The networking/communication interface may transmit and send data to the network, other computing devices, or the like. For example, the networking/communication interface may transmit data to and from other computing devices through the network which may be a wireless network (e.g., Wi-Fi, Bluetooth, cellular network, etc.) or a wired network (Ethernet), or a combination thereof. In particular, the network may be substantially any type of communication pathway between two or more computing devices. For example, the network may be wireless, wired, or a combination thereof. Some examples of the network include cellular data, Wi-Fi, Ethernet, Internet, Bluetooth, closed-loop network, and so on. The type of network may include combinations of networking types and may be varied as desired. In some embodiments, the network communications may be used to access various aspects of the SR platform form the cloud, another device, or dedicated server.

In various embodiments, the network communication connections 80 may also receive communications from one or more of the other systems including the input/output connection 30, the memory components 40, the camera and/or sensors 50, and/or the display 60. In a number of embodiments, the SR computing system 10 uses a driver memory to operate the various peripheral devices including the display 60, the I/O 30, the sensors/camera 50, and/or the operation hardware/power supply 70, and/or the network communications 80.

In accordance with various embodiments, the system provides the user ability to load data from existing tools into the virtual space, world, or landscape. For example, an input/output interface allows the computing device to receive inputs from a user and provide output to the user. For example, the input/output interface may include a capacitive touch screen, keyboard, mouse, camera, stylus, or the like. The type of devices that interact via the input/output interface may be varied as desired. Additionally, the input/output interface may be varied based on the type of computing device used. Other computing devices may include similar sensors and other input/output devices.

The memory stores electronic data that may be utilized by the computing device. For example, the memory may store electrical data or content, for example audio files, video files, document files, and so on, corresponding to various applications. The memory may be, for example, non-volatile storage, a magnetic storage medium, optical storage medium, magneto-optical storage medium, read only memory, random access memory, erasable programmable memory, flash memory, or a combination of one or more types of memory components.

The display 60 may be separate from or integrated with the computing system 10. For example, for cases in which the computing system 10 is a smart phone or tablet computer, the display 60 may be integrated with the computing device and in instances where the computing system 10 is a server or a desktop computer, the display 60 may be separate from the computing device. In some embodiments, such as when the display 60 is a VR headpiece, the display is separate from the computing system 10 even when it is a smart phone or tablet computer. The display 60 provides a visual output for the computing system 10 and may output one or more graphical user interfaces (GUIs).

In accordance with various embodiments, the user can move around the virtual space in any direction desired to be enabled. The SR generator 46 may receive information from the I/O 30, sensors/camera 50, the network communication 80, and/or the avatar data 49 so as to render the SR environment continuously from different perspectives as the user provides input through the I/O 30, sensors/camera 50, or the network communication 80 to change the user's relative location in the SR environment. In accordance with various embodiments, multiple users can enter the SR environment and view the same graphics, along with transformations made by any user. Thus, the SR system provides the user the ability to be immersed in the data and using transportation mechanisms to maneuver within the data set. In accordance with various examples, a user can view data from different perspectives in a three dimensional layout or world. The world can be viewed using dynamic methods showing different perspectives of the real-world forms and landscapes. In some examples, the viewing methods can also take on real-world forms/avatars, including but not limited to: desktops, cars, helicopters, boats, walking, flying, etc. In accordance with various embodiments, the SR environment provides the user the ability to interact with the data using hand/controller, movements, standard keyboard/mouse, or similar interactive devices via one or more communication ports such as the I/O 30, sensors/camera 50, or the network communication 80. In some embodiments, the avatar data 49 can have a pre-recorded exploration path through the SR environment. In accordance with various embodiments, the relationship between representative attributes and source attributes (e.g., the conversion) is adjustable allowing the user to change which variable is mapped onto which attribute while in the experience. In one example, the user can use the I/O 30, sensors/camera 50, or the network communication 80 to access the interface and make changes as discussed above. In various examples, the user can use the I/O 30, sensors/camera 50, or the network communication 80 approach an agglomerated asset or representative attribute within the SR environment and interact with it to view, modify, or analyze source data, representative attribute types, conversion factors, or assets. In accordance with various embodiments, the interaction is configured to visually output statistical relationships between attributes while in the experience. For example, such outputs may include trend-line visualizations as well as regression equations and statistics including but not limited to R-Squared, betas, standard errors, t stats and p stats. This information can be viewed by approaching assets or groups of assets.

In accordance with various embodiments, the SR generator 46 dynamically changes the environment in response to user input, the conversion engine 45, and/or the source data 41. As discussed above, the SR generator can dynamically render new perspectives, views, or details of the SR environment based on input from the user. In other embodiments, the SR generator can also or alternatively dynamically render the SR environment based on dynamically changing source data 41 and/or a dynamically changing conversion engine 45. For example, the source data 41 can dynamically pull updated data. For example, users may be continually updating the data or the data may be pulled or streamed from internet sources. As the source data 41 changes, the SR generator can render a dynamically updated SR environment that reflects those changes. An example result of this sort of dynamically updating source data is that an avatar walking through the SR environment in the morning would see a different SR environment than if walked through in the evening. In an application in which the source data is represented via agglomerate assets as trees. The trees could grow, shrink, bear fruit, loose fruit, change fruit, change colors, etc. through the course of a few minutes, hours, days, weeks, etc. depending on how the data changes. This source of dynamic updating of user input, conversion engine 45 algorithms, and/or source data allow for system to display a broad comparison of quickly changing data in a way that allows users to discern patterns that traditional displays do not.

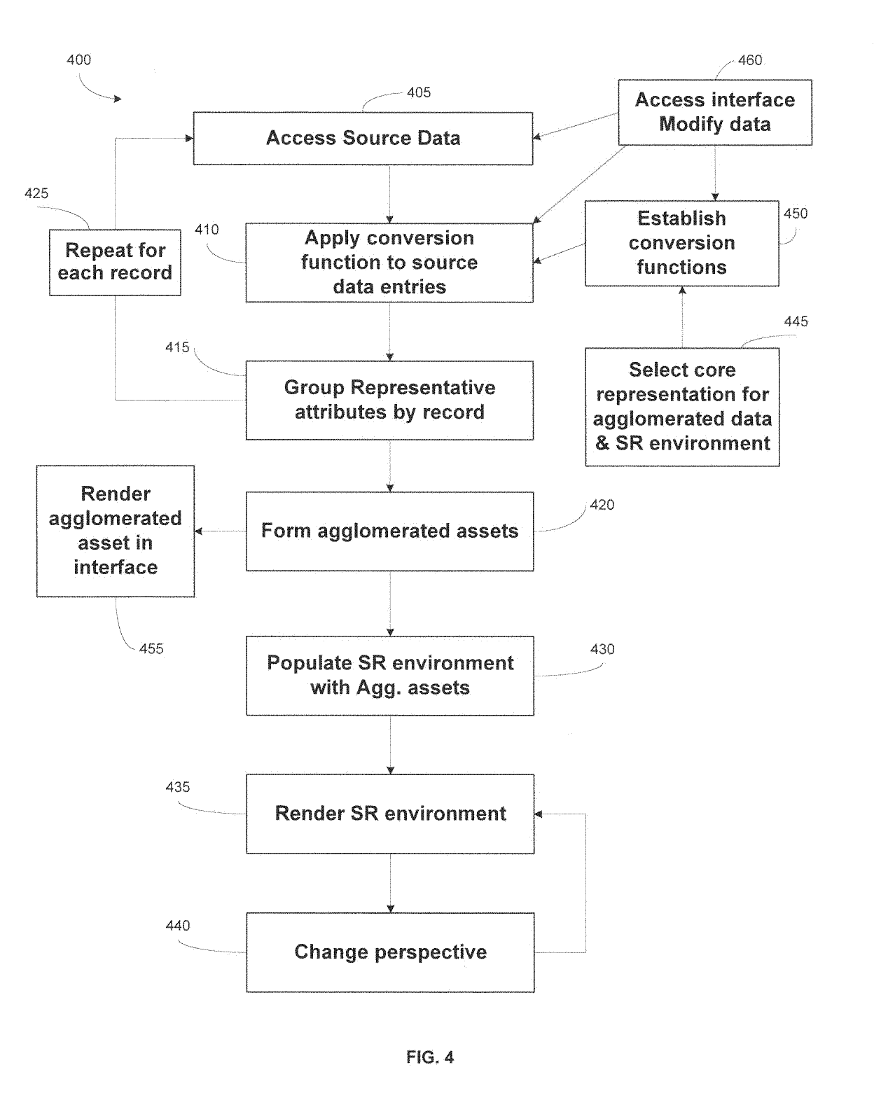

FIG. 4 illustrates a block diagram of a process 400 for converting source data into agglomerated assets and then implementing the simulated reality environment with the agglomerated assets. The process 400 includes accessing 405 source data. In various embodiments, the user can input the source data directly for the system to access. In other embodiments, the process accesses the source data from an existing database file or the like.

The source data is then converted (410) to representative data. In particular, each entry of source data is converted to an entry of representative attributes. As discussed above, any of a plurality of conversion functions can be used. Each entry can utilize a different conversion function. The conversion functions can correspond to the distinct intrinsic characteristics of the asset such that the output representative attributes correspond to the distinct intrinsic characteristics of the asset for each record or portion of a record that is intended to be represented by an asset or an agglomerated asset.

The representative attributes are grouped (415) to correspond with the source data record, portion of record, or group of records or any other suitable association for intended representation as an agglomerated asset. In particular, an asset can be selected (445). The selection of the asset also influences the selection or establishment (450) of the conversion factors since, the conversion factors form the basis for ascribing a characteristic of the asset as applied via the representative attributes. This selection can be done automatically or manually.

The agglomerated asset is formed based on the group of representative attributes (420) that are contextually related to the asset. Processes 405-415 are repeated and agglomerated assets are accumulated (425) to form a plurality of agglomerated assets to have an agglomerated asset set allowing various proxy comparison of the various records, partial records, or groups of records in the source data.

With one or more agglomerated assets, the SR environment is populated (430) with the agglomerated assets. Once populated, or as it is being populated, the SR environment can be rendered (435) for display on a display device allowing user interaction with the environment. As the user moves through the SR environment, the perspective of the relationship between the various agglomerated assets changes. With every perspective change (440) the SR environment renders again to provide a continuous flow and interaction between the user and the SR environment as a whole. The exploration of the environment allows for countless different perspectives through the interaction of the relationships between the source data in the data set. Additionally, in accordance with various embodiments, the agglomerated assets can be individually displayed (455) on a graphical interface illustrating a single group or related groups of the agglomerated assets in the SR environment. The interface also allows form modification of the source data, the conversion (e.g., representative attribute type, such as leaf color) and/or the conversion functions (e.g., the values of the attribute type, such as leaf color red). Thus, a user can access (460) the interface and modify.

In accordance with various embodiments, various assets may be assigned to the SR environment without association to representative attributes. For example, the landscape could be an asset or the background. As translated into the SR environment, the landscape could define a the to establish the location (e.g. on an X and Y-axis) of other assets. Thus, the relative position of one asset relative to another is an easy-to-see comparison of these factors. Furthermore, various settings of the SR environment may be adjustable in the interface or similar location, allowing a user to set characteristics of the environment such as the scale (e.g. range of X and Y-axis).

As discussed in detail above, the SR computing system 10 provides for the proxy representation of data in a variety of manners. While not to be limiting, an example of the system and operation is provided below.

### Example

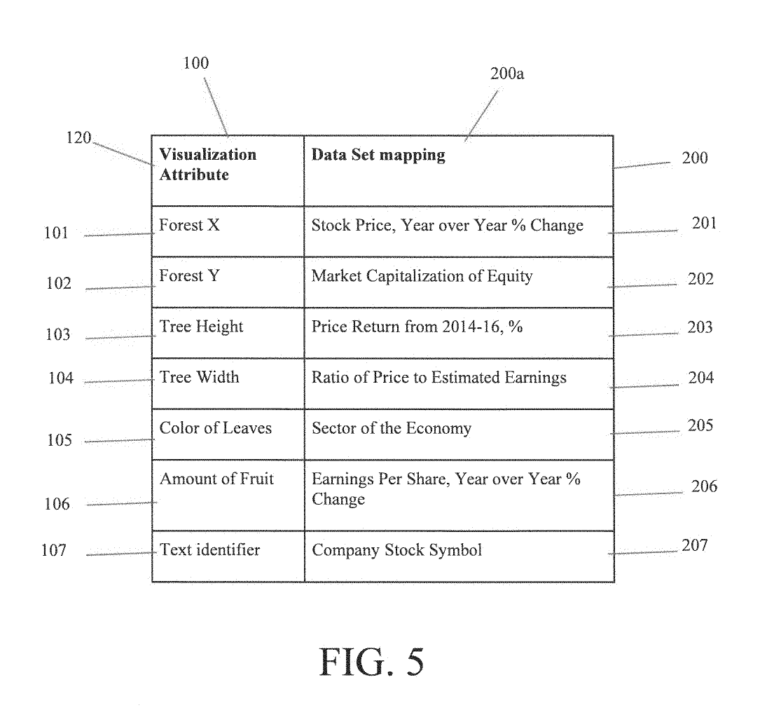

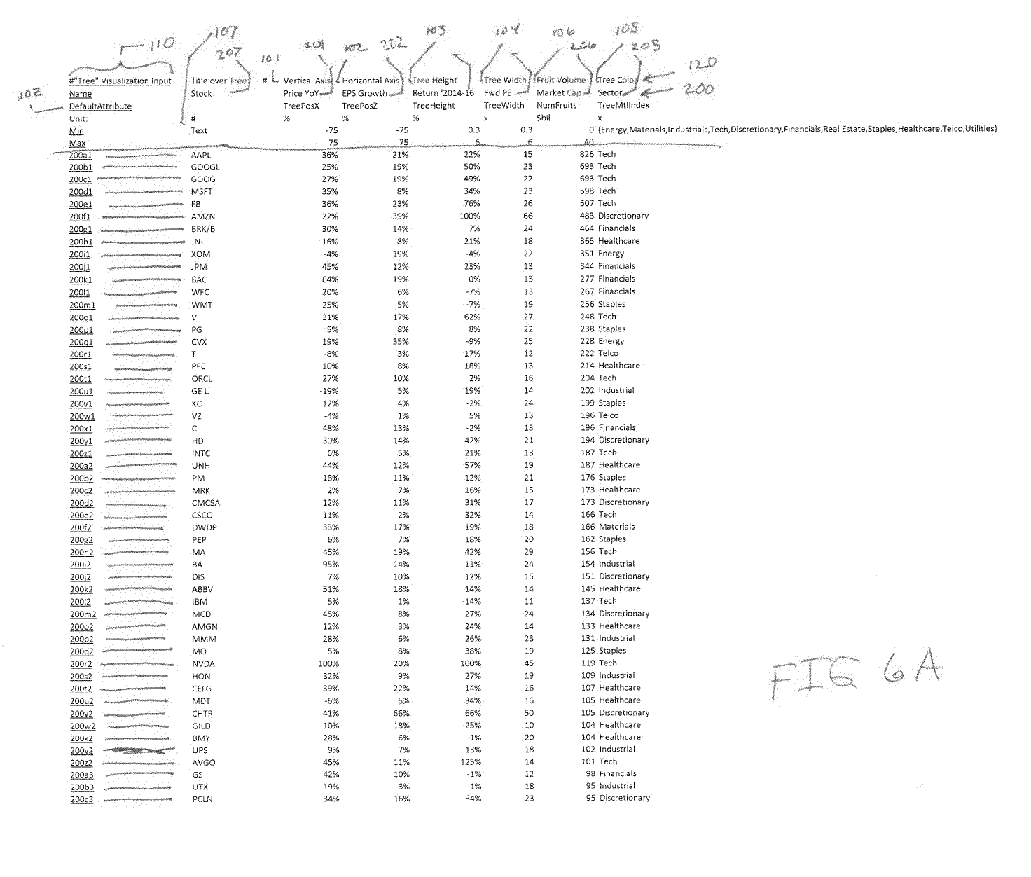

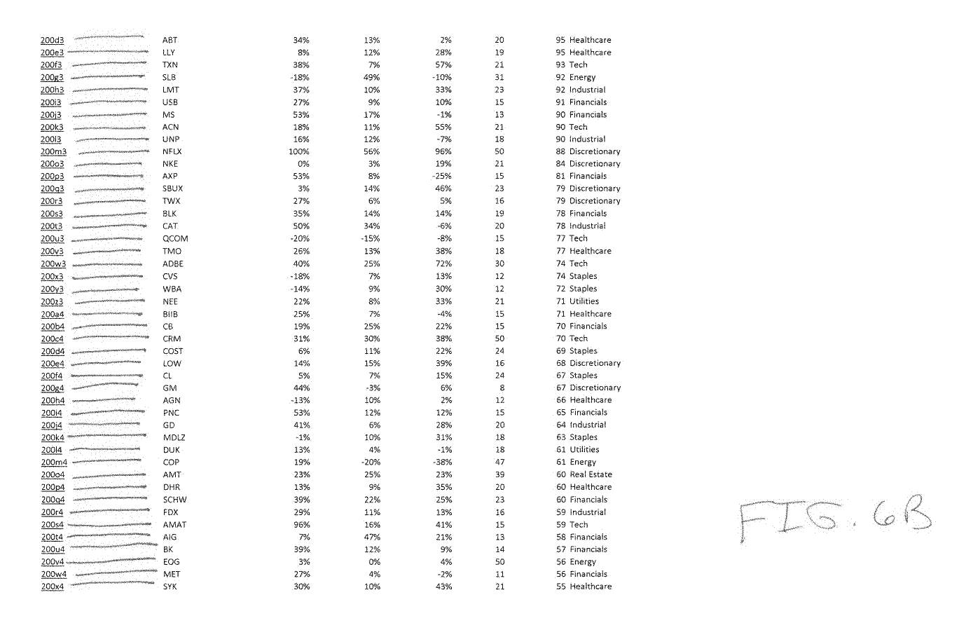

In accordance with one example, the SR computing system 10 maps source data 200 to representative attributes 100 and at least partially represents the source data 200 by proxy as a forest of trees in the SR system. As illustrated in FIG. 5, the SR computing system 10 maps source attributes (e.g., 201, 202, 203, 204, 205, 206, 207), that relate to corporate information, to the various representative attributes (e.g., 101, 102, 103, 104, 105, 106, 107), that relate to intrinsic characteristics of trees, for representation in the SR environment. The SR environment allows for the comparison, evaluation, analysis and/or modification of multiple records (e.g., 200a-e shown, for example, in FIG. 6). In particular, the first entry 201 for a particular company is the Stock Price, Year over Year Percent Change, which correlates with the first representative attribute 101 of a tree. This locates the tree on an X axis in the SR environment. The second entry 202 for a particular company is the Market Capitalization of Equity, which correlates with the second representative attribute 102 of a tree. This locates the tree on a Y axis in the SR environment. The third entry 203 for a particular company is the Price Return from 2014-16 in percent, which correlates with the third representative attribute 103 of a tree. This sets the tree height in the SR environment. The fourth entry 204 for a particular company is the Ratio of Price to Estimated Earnings, which correlates with the fourth representative attribute 104 of a tree. This sets the tree width in the SR environment. The fifth entry 205 for a particular company is the Sector of the Economy, which correlates with the fifth representative attribute 105 of a tree. This sets the color of the leaves on the tree in the SR environment. The sixth entry 206 for a particular company is the Earnings Per Share, Year over Year Percent Change, which correlates with the sixth representative attribute 106 of a tree. This sets the amount of fruit on a tree in the SR environment. The seventh entry 207 for a particular company is the Company Stock Symbol, which correlates with the seventh attribute 107. Of note, the seventh attribute 107 is not a representative attribute but is instead an example of the source data being directly represented in the SR environment. Here the company stock symbol is source data and is directly used to label trees in the SR environment for easier recognition of what each tree represents. Thus, the attributes of each agglomerated asset in the SR environment can be a mix of representative attributes that correlate to characteristics of the asset (the tree) and direct source data shown in the SR environment.

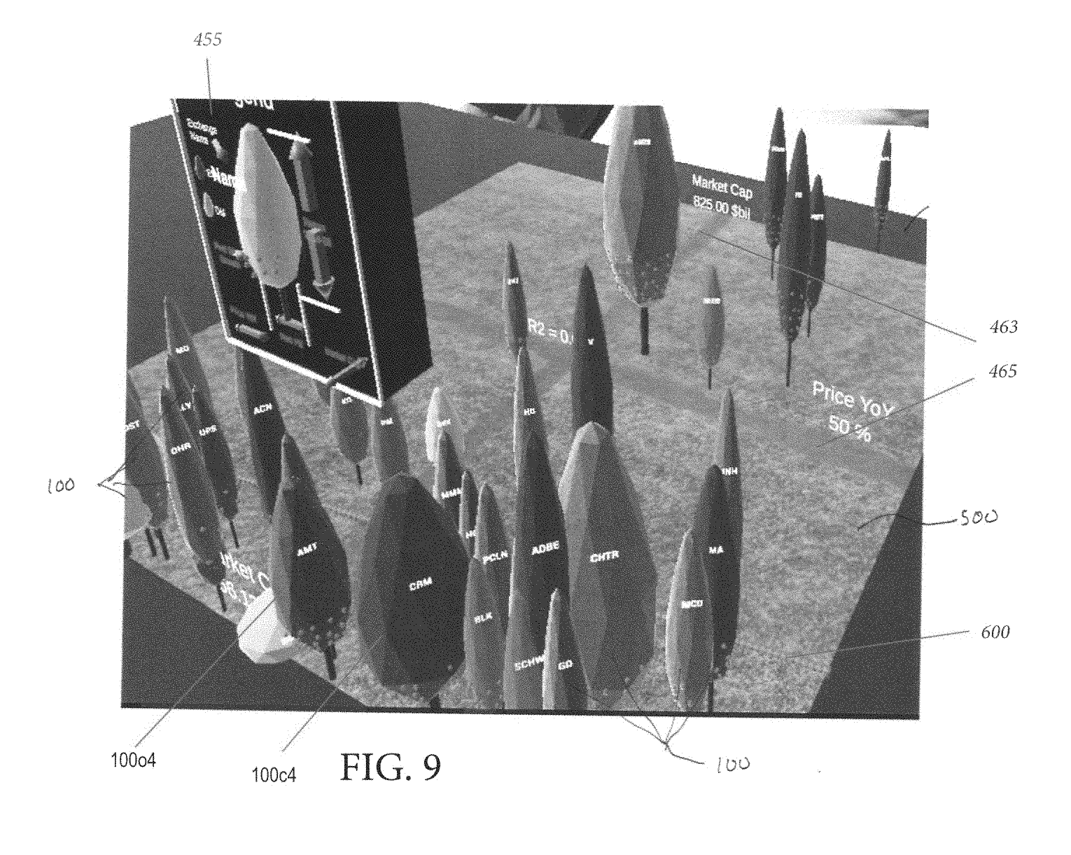

In this example, the user enters data into a spreadsheet or loads a stored spreadsheet illustrated in the table of FIGS. 6A and 6B (e.g., example database), this table includes the same mapping information as FIG. 5 with the inclusion of specific values for the companies in the entries 200a1-200x4. Each of the entries 200a1-200x4 correlates to representative data. While not shown in the chart, the representative data 100o4 and 100c4 are shown in the FIGS. 9-14 illustrating the direct relationship for the title/stock name shown in the SR environment. Each record 200a1-200x4 includes at least one source attribute 200a. As shown, each of the 98 companies includes seven source attributes shown as entries 201-207. The collection application is stored in such a way as to allow access by the SR platform. For example, the system loads or generates a spreadsheet based on data obtained from the cloud (or a user saves the spreadsheet) to an SR platform location or more specifically the memory 40 allocated therein, as discussed above. The SR platform is configured to receive or access a user's data from the spreadsheet shown. As is illustrated in FIGS. 6A-6B, with the complexity of the amount of information for so many different companies (e.g., the representation of 98 different companies as a visual forest of trees serving as agglomerated assets), the SR system 10 allows for greater accessibility and efficient analysis by the user.

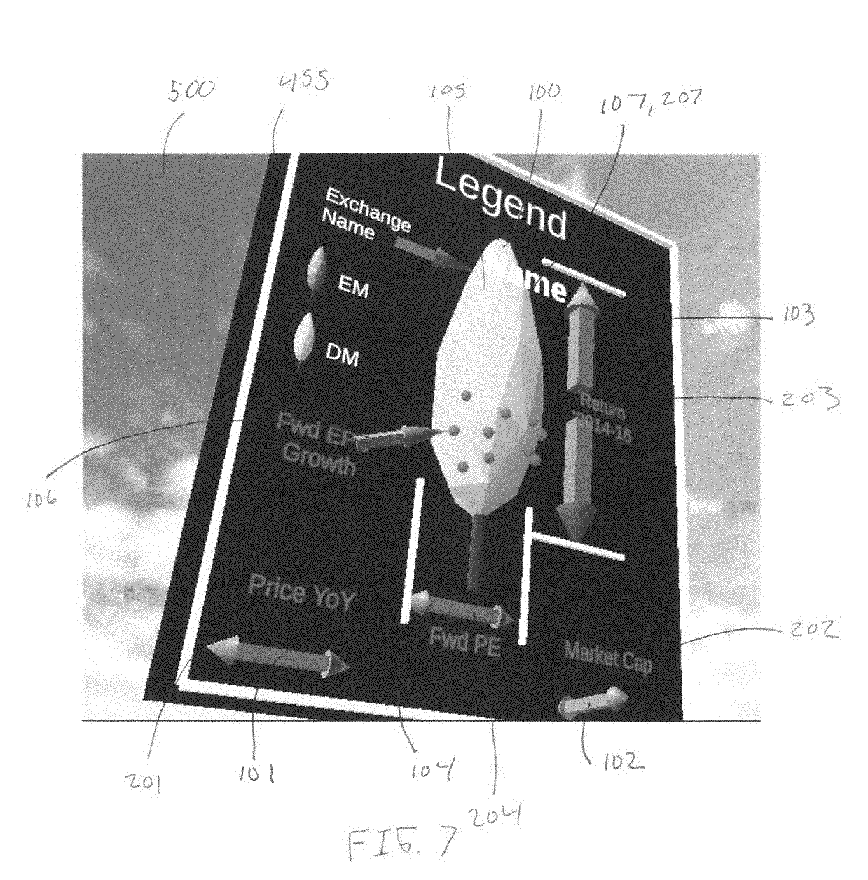

In this example, the table includes default values 101z for the attributes 101-107 correlated to values, types, or characteristics of the asset. As translated into the SR environment, the forest floor defines the grid to establish a tree's location on an X-axis 465 and Y-axis 463. As shown, for example, the default values for the floor axes in this example are −75 to 75 for each. Thus, the relative position of one tree to another is an easy-to-see comparison of these factors. As shown in FIGS. 7-10, the source data and relationships can be viewed and updated in real time via the SR environment.

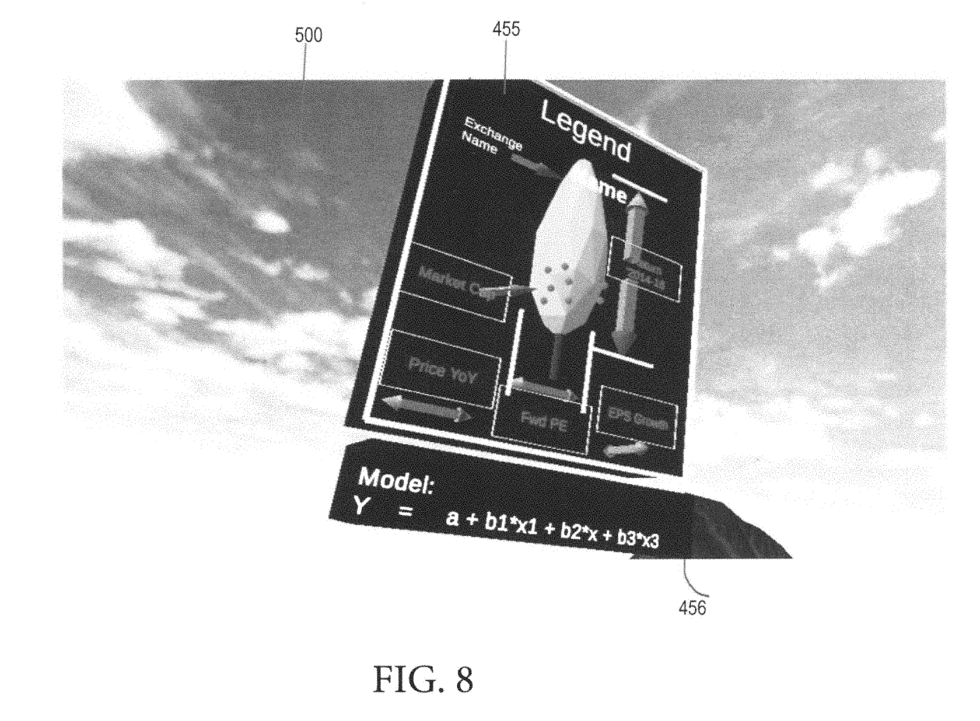

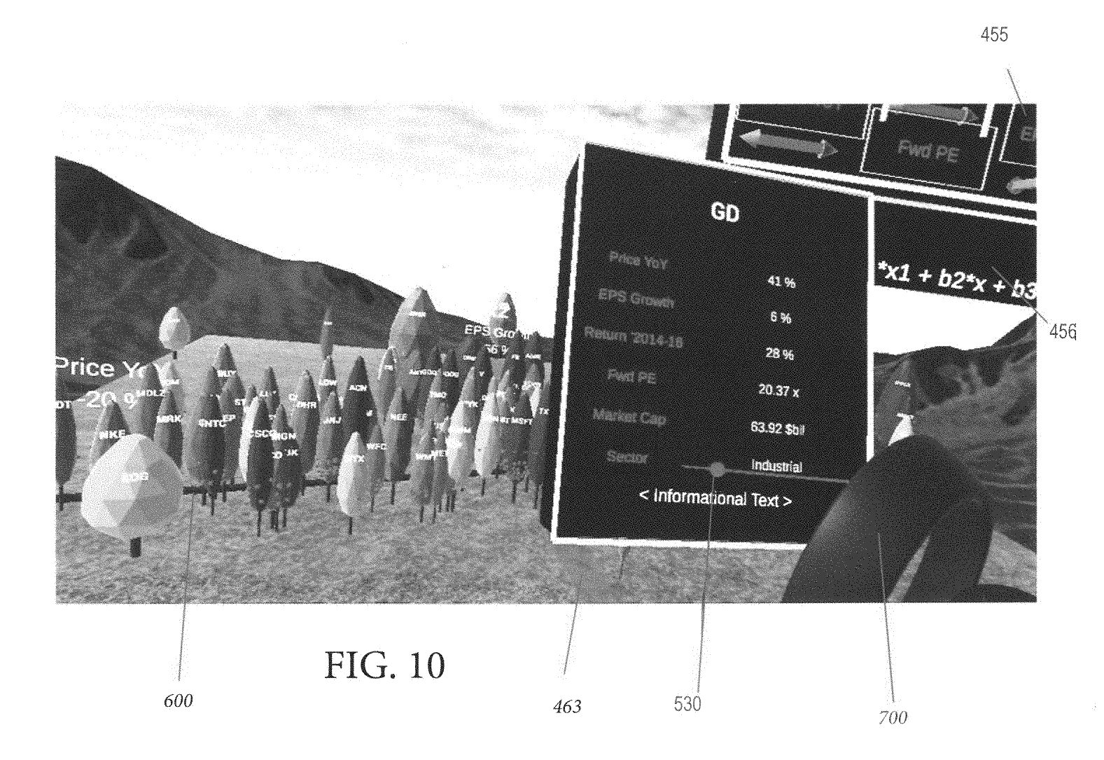

FIGS. 7-10 illustrate a dynamic interface platform, which provides the ability to swap variables/attributes, algorithms, etc. As shown in FIG. 7, the user has access to an interface 455 that can show each agglomerated asset separately. As shown is an example-agglomerated asset in a VR platform. Alternatively, user could modify the source data (e.g. in the spreadsheet) to have the same effect as the interface. The correlation of the source data 201-207 as mapped onto a tree is shown specifically in FIG. 7. This interface is an example of one that can be used for adding a new record to the source data. Any desired variable can be mapped to any of these attributes, and the SR interface allows the user to swap variables onto any attribute while in the experience. In FIG. 8, a dynamic legend is shown that functions as part of the interface platform 455. An equation can be moved (e.g., drag and drop) into the legend to establish the parameters by which the data related thereto operates. In accordance with various embodiments, the interface can also function as a legend that is interactive, providing the user ability to adjust the data mapping via the legend to drive changes in the visualization. The legend and interface can be separate. The legend can be seen over the “forest” of data in the first image below. FIG. 6 shows example variable mappings that can be dynamically modified while in the experience. The relationship between the representative attributes and the source attributes or between other entities within the SR interface can include geometric algorithms. The interface also includes a display that provides an individual data point to be displayed when the corresponding agglomerated asset is selected. As can be seen in FIG. 10, each piece of source data can be viewed from the data point display 530. The FIGS. 9-14 depict the SR environment 500 showing a 3D simulated landscape with trees forming the agglomerated assets for easy comparison across the landscape. The platform enables the user to enter the SR environment and open, access, review, or analyze the 3D visualization by interacting with a controller (e.g., hand controller) to move about and manipulate the environment. Using SR system 10, the user can immerse him- or herself in a natural representation in the SR environment, such as the forest shown in FIGS. 9-14, and better understand the complex data relationships. In accordance with various embodiments, the user can move around the virtual space in any direction. In accordance with various embodiments, multiple users can enter the experience, regardless of the type of SR platform (e.g., whether in VR, AR, MR, or at a desktop), and view the same graphics, along with transformations made by any user.

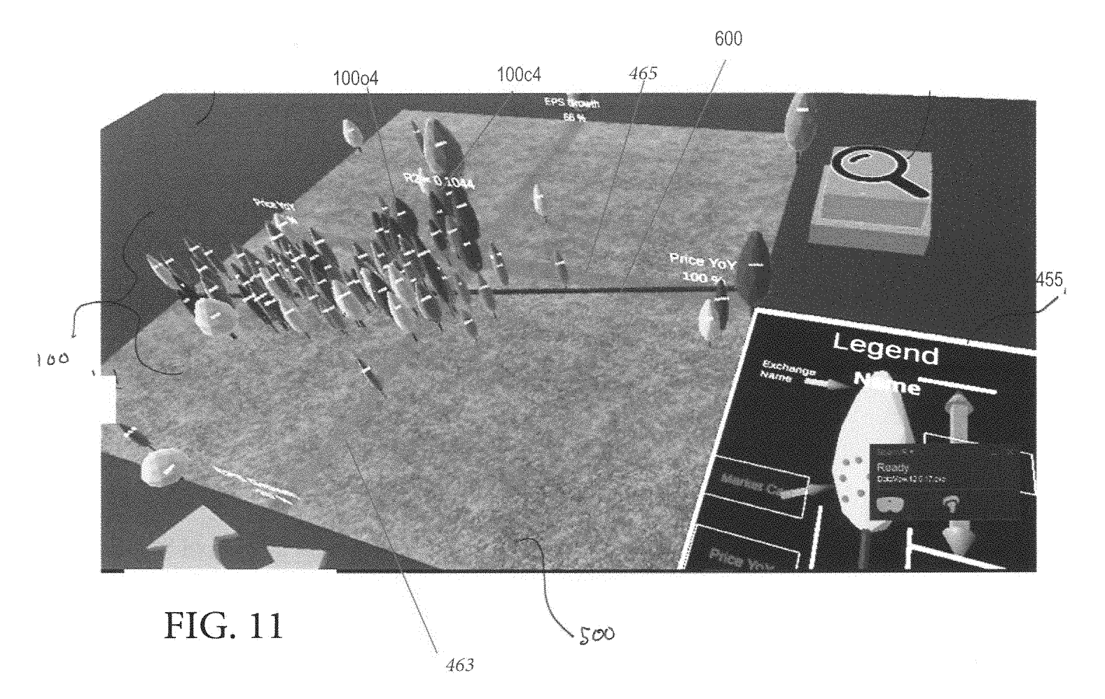

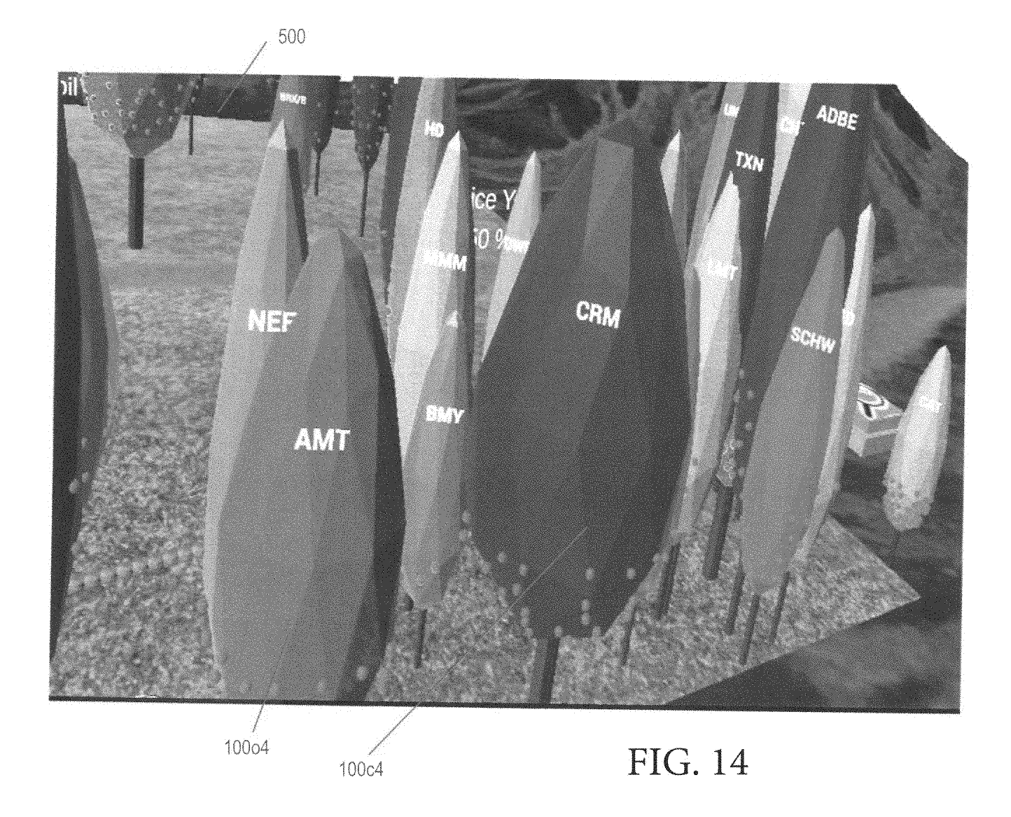

FIGS. 9-10 illustrate closer views of the SR environment 500. As shown in FIG. 9, the X axis only extends from −50% to 50%, providing a closer perspective. FIGS. 9-14 all illustrate renderings after a user moves to a different location, i.e., different viewpoints in the SR environment 500. The interface can also be shown anywhere in any perspective of the SR environment, as shown in FIG. 10. The view can be expanded for a macro version of the forest, as shown in FIG. 11. Here the X and Y axes are adjusted closer to their extremes (e.g., the tree representing record 200v2 is shown on the distant edge as 66% EPS growth). Thus, every agglomerated asset from the data set is shown. Whereas, an extremely close perspective can also be used, as is the case with FIG. 14. Here, a small group of agglomerated assets is shown and each of the titles is clearly discernable, as well.

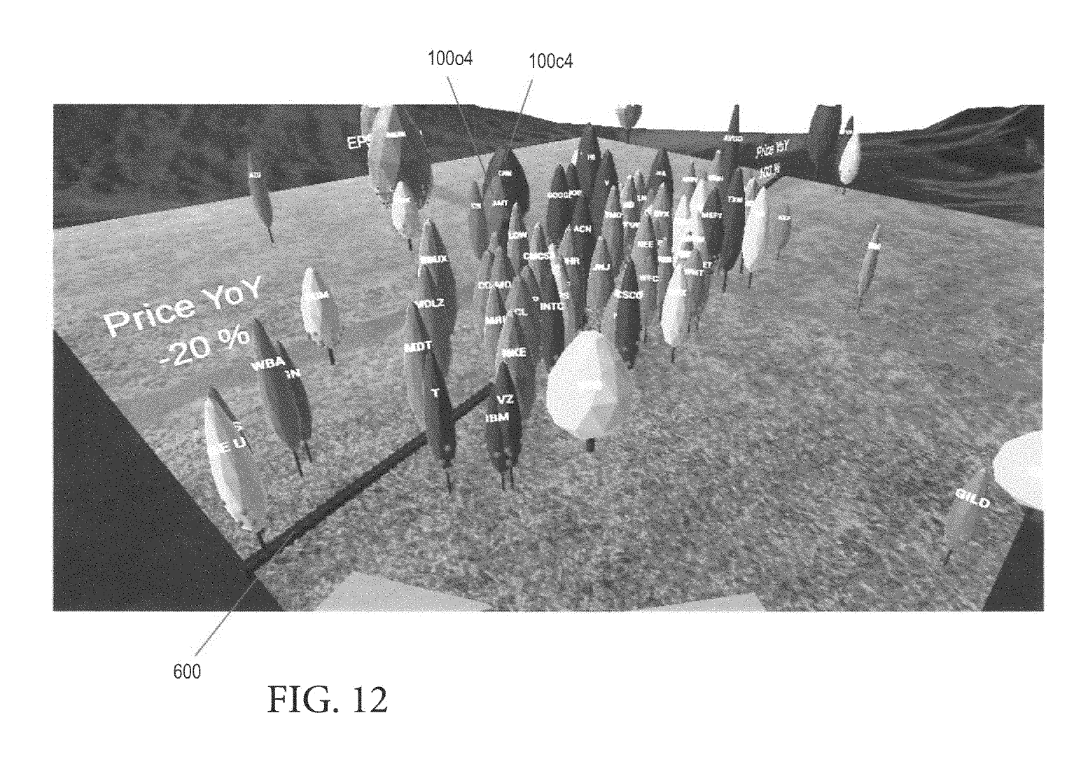

Other data analysis features are also usable in the system. FIGS. 11 and 12 both show a regression line 600 extending across the SR environment. The regression line appears as a result of a statistical comparison of the source data entry 201 and 202 for each of the records. The SR environment allows for a verification of this, as the trees tend to group around and follow the line.

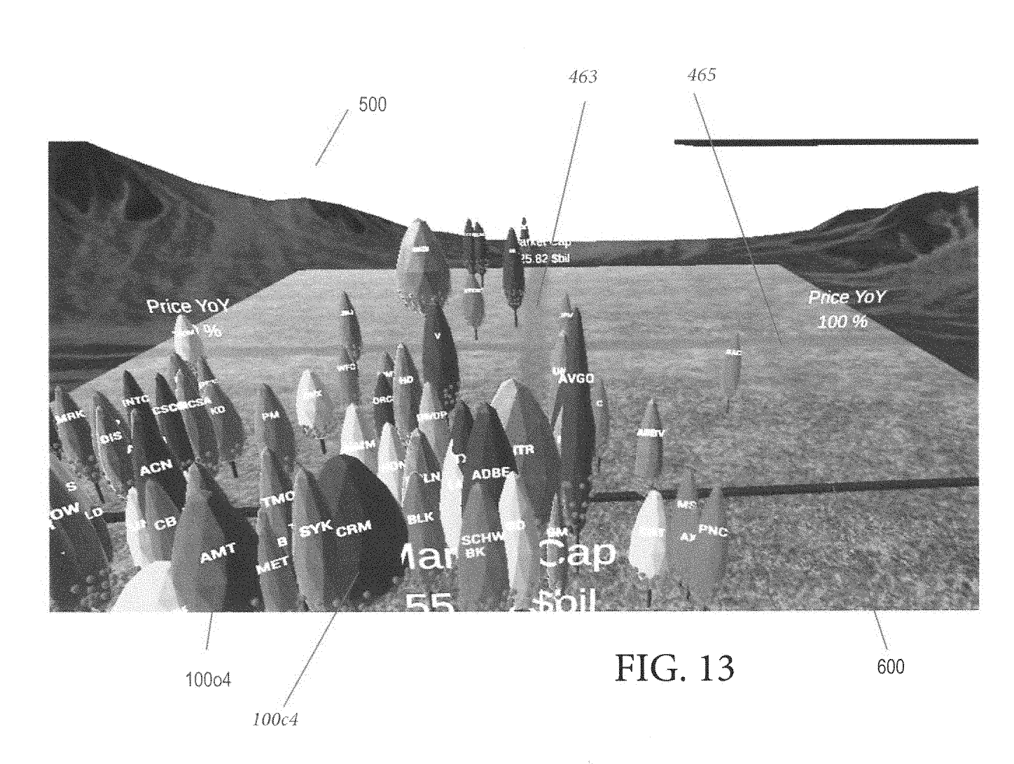

Because of the live interaction and the ability to modify data and relationships, the entire environment can be modified on the fly. FIG. 13 illustrates an example where the Y axis was switched from being correlated with EPS Growth and instead the Y axis as shown in FIG. 13 is correlated with Market Cap. Thus the entire forest landscape is changed in real time.

As discussed above, FIGS. 9-14 also show the changing perspectives of the user. This changing of perspectives in the SR environment interface allow a user to fully explore and integrate into the world. Accordingly, the SR system 10 provides the user with the ability to: (1) move around the SR environment 500, (2) change which data entry is mapped to which attribute via a dynamic legend, (3) build multi-variate models based on the data set (producing relevant regression stats) by selecting variables as independent and dependent on the dynamic legend, and/or (4) exclude certain variables on the visualization using the dynamic legend and exclude certain data points (e.g., outliers) by selecting them with controllers. In accordance with various embodiments, the platform is an exportable image such that the user has the ability to capture the SR environment 500 according to a particular perspective as a 3D model or 2D video/picture, and export the files in order to share. Additionally, users can share or show the SR environment to other people who have also entered the SR environment via a VR headset. Additionally, the SR system is configured for allowing the ability to scale the data representation relative to the viewer's virtual or perspective size.

The power source provides power to the various components of the computing device. The power source may include one or more rechargeable, disposable, or hardwire sources, e.g., batteries, power cord, or the like. Additionally, the power source may include one or more types of connectors or components that provide different types of power to the computing device. The types and numbers of power sources may be varied based on the type of computing devices.

The sensors may provide substantially any type of input to the computing device. For example, the sensors may be one or more accelerometers, microphones, global positioning sensors, gyroscopes, light sensors, image sensors (such as cameras), force sensors, and so on. The type, number, and location of the sensors may be varied as desired and may depend on the desired functions of the system.

The term “about,” as used herein, should generally be understood to refer to both the corresponding number and a range of numbers. Moreover, all numerical ranges herein should be understood to include each whole integer within the range. While illustrative embodiments of the invention are disclosed herein, it will be appreciated that numerous modifications and other embodiments may be devised by those skilled in the art. For example, the features for the various embodiments can be used in other embodiments. Therefore, it will be understood that the appended claims are intended to cover all such modifications and embodiments that come within the spirit and scope of the present invention.

1. A data representation system, comprising:
a display device;
a non-transitory memory containing computer-readable instructions operable to create a simulated reality; and
a processor configured to process the instructions for carrying out the following steps for creating the simulated reality:
accessing an asset suitable to display in the simulated reality;
accessing source data a plurality of attributes;
converting a portion of the source attributes to representative attributes, with the representative attributes having a contextual association with the asset;
applying the representative attributes to the asset and thereby forming an agglomerated asset; and
displaying the agglomerated asset on the display device.

2. The data representation system of claim 1, wherein the processor is further configured to populate the simulated reality with the agglomerated assets in a spatial relationship to one another.

3. The data representation system of claim 2, wherein two or more agglomerated assets are spatially arrange in the simulated reality.

4. The data representation system of claim 3, wherein the processor is further configured to render the simulated reality on the display device from changeable viewpoints of the simulated reality.

5. The data representation system of claim 4, further comprising an input device, wherein the processor is further configured to receive information from the input device allowing a user to change the viewpoint of the simulated reality.

6. The data representation system of claim 5, wherein the different viewpoints allow different groups of agglomerated assets to be viewed on the display device relative to one another from different perspectives.

7. The data representation system of claim 1, wherein each source attribute has a direct relationship to an individual representative attribute.

8. The data representation system of claim 1, wherein each source attributes have different relationship types forming the relationship to the individual representative attribute.

9. The data representation system of claim 8, wherein at least one relationship type is an algorithmic relationship.

10. The data representation system of claim 9, wherein the algorithmic relationship is a scaler algorithmic relationship that converts a range of variables into a discrete representative attribute.

11. The data representation system of claim 9, wherein the representative attribute is at least one of a color, an appendage, a size, a shape, a texture, or a second related asset of the asset.

12. The data representation system of claim 8, wherein at least one relationship type is a direct relationship having a preassigned value input by a user.

13. The data representation system of claim 8, wherein the direct relationship is established by assigning a source data variable to a discrete representative attribute including at least one of a color, an appendage, a size, a shape, or a dependent entity.

14. The data representation system of claim 8, further comprising accessing a second asset, wherein a representative attribute is applied to the second asset contextually relating the second asset to the agglomerated asset.

15. The data representation system of claim 1, wherein the asset is a natural construct.

16. The data representation system of claim 1, wherein the asset is a manmade construct.

17. The data representation system of claim 1, wherein the simulated reality is a virtual reality platform.

18. The data representation system of claim 1, further comprising a real environment input device.

19. The data representation system of claim 18, wherein the simulated reality is an augmented reality platform and the processor receives information from the real environment input device and renders the agglomerated asset in the display showing an image of a real environment on the display device.

20. The data representation system of claim 1, wherein the simulated reality is a 3D representation on a viewing screen.

21. The data representation system of claim 1, wherein the simulated reality includes an input platform that allows assigning or modifying information relative to each attribute or allows adding an attribute and associated information to the representative data.

22. A data representation system, comprising:
a display device;
a non-transitory memory containing computer-readable instructions, operable to create a simulated reality; and
a processor configured to process the instructions for carrying out the following steps for creating the simulated reality:
providing a plurality of agglomerated assets, each agglomerated asset having:
a plurality of representative attributes, with each attribute representative of different source data elements, and
an asset, wherein the representative attributes are related, forming distinct intrinsic characteristics of the asset,
populating the simulated reality with two or more agglomerated assets in a spatial relationship to one another, and
rendering the simulated reality on the display device to form changeable viewpoints of the simulated reality.

23. The data representation system of claim 22, further comprising an input device, wherein the processor is further configured to receive information from the input device, allowing a user to change the viewpoint of the simulated reality.

24. The data representation system of claim 23, wherein the different viewpoints allow different groups of agglomerated assets to be viewed on the display device relative to one another from different perspectives.

25. The data representation system of claim 22, wherein the asset is a natural construct.

26. The data representation system of claim 22, wherein the asset is a manmade construct.

27. The data representation system of claim 22, wherein the simulated reality is a virtual reality platform.

28. The data representation system of claim 22, further comprising a real environment input device.

29. The data representation system of claim 28, wherein the simulated reality is an augmented reality platform and the processor receives information from the real environment input device and renders the agglomerated asset in the display showing an image of a real environment on the display device.

30. The data representation system of claim 22, wherein the simulated reality is a 3D representation on a viewing screen.

31. The data representation system of claim 22, wherein the simulated reality includes an input platform that allows assigning or modifying information relative to each attribute or allows adding an attribute and associated information to the representative data.

32. A method for representing data in a simulated reality, the method comprising:
accessing multi-attribute source data a plurality of attributes;
converting a portion of the multi-attribute source data to representative data;
accessing the representative data;
forming an agglomerated asset based on the representative data with the agglomerated asset being based on an asset suitable for display in the simulated reality, wherein each of the attributes are related and form a distinct characteristic of the asset forming the basis of the agglomerated asset;
populating the simulated reality with two or more agglomerated assets in a spatial relationship to one another; and
outputting the agglomerated asset to the display device.

33. The method of claim 32 further comprising, rending the simulated reality on the display device to form changeable viewpoints of the populated simulated reality.
